(19) United States
(12) Patent Application Publication
(10) Pub. No.: US 2010/0167739 A1
(43) Pub. Date: Jul. 1, 2010

(54) Handset Handover

(76) Inventor: David E. Hughes, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 11/989,937

(22) PCT Filed: Aug. 2, 2006
(86) PCT No.: PCT/GB2006/002874

§ 371 Date: Feb. 4, 2008

(30) Foreign Application Priority Data
Aug. 24, 2005 (EP) 05255209.8

(51) Int. Cl. H04W 24/00; H04W 88/06

(52) U.S. Cl. 455/436; 455/552.1

(57) ABSTRACT

A mobile handset capable of operation on more than one wireless system has means for periodically testing for the availability of at least one system whilst operatively connected to another system, wherein the periodicity of the testing process is made at one rate when a call is in progress and at a second rate when no call is in progress (on standby). This significantly reduces power consumption when on standby, without impairing handover reliability if a call is in progress.

This invention relates to mobile telephone handsets.

Mobile telephone handsets are designed to communicate with a telecommunications network using a wireless connection (usually radio) to a fixed base station, which communicates with a network switching system and thus with any other telephone connected to the same switching system, or another one with which it is interconnected.

So-called “cordless” handsets are designed to work only with dedicated base stations. In some systems the dedicated station may be changed from time to time, but not during the progress of a call. “Cellular” handsets, on the other hand, are capable of operation with any one of a large number of base stations. In general, the base station with the strongest signal as detected by the mobile handset will communicate with the handset. Unlike the cordless system, the handset can change its communication path from one base station to another during the progress of a call. This allows a call to continue whilst a user moves from one coverage area to another, as may happen when travelling at speed, or in and out of buildings. The decision to change is taken based on measurements carried in the signalling overhead.

Some handsets are capable of operating on more than one wireless system, to allow their use in any area where at least one of the systems is available. Examples include the “dual mode” cellular handsets used by people who do a lot of foreign travel between regions using different cellular radio standards. Another example is described in International Patent Specification WO98/03002, in which calls are connected to the fixed telephone system through a DECT cordless connection if one is available, and connected to the cellular telephone system otherwise. In these examples a call, once established using one telephony system, remains connected through that medium throughout the duration of the call. Thus, in the International specification referred to above, the call remains connected through the cellular network even if the handset is moved within range of the cordless base station. Conversely, if the call starts on the cordless connection, and the handset is taken out of range of the cordless base station during the call, the call is dropped and the user must re-establish the call through the cellular system. Such systems avoid the inconvenience of having two separate handsets, by providing the capabilities of both in one apparatus, but they provide no additional functions.

Handsets are now being developed which allow connected calls to be transferred between different wireless systems without the need to drop the call and re-establish it. International Patent Specification WO97/36442 describes a system in which a cellular telephone may be physically connected to a fixed terminal which is in turn connected to the cellular network in such a way that it appears to be a standard base station. When the handset is disconnected from the fixed station, and establishes wireless connection with the nearest normal base station, it simply appears to the cellular network to hand over between the “virtual” base station and the normal one. In this prior art system, the connection is made to the fixed terminal by means of an electrical, optical or ultrasonic link, but more recent proposals make use of short range radio connections using protocols such as the “Bluetooth” standard, or the 802.11 (“Wi-Fi”) standard.

The use of radio for the local link requires the handset to be aware of whether the local connection is available. This requires the handset to test the radio environment periodically for properties such as packet loss and signal strength to determine whether the short range base station is within range, and effect a handover between the two systems if it comes within range, or goes out of range. The latter situation determines how often the testing must take place, because the call must be handed over to the cellular system in time to avoid a call being dropped whilst in progress. A typical sampling rate to achieve this would be 200 msec.

The power consumed by this testing process is small in comparison with that used by the handset when a call is in progress. However, it is significant in proportion to the power consumed by the handset when not engaged on a call, but left switched on so that it can respond to incoming calls, a condition commonly referred to as “standby”. Consequently the sampling process will cause a considerable drain on the battery life of the handset when in the standby condition, and results in an unacceptable reduction in the time the handset may be left in that condition between recharging.

According to a first aspect of the invention, a mobile handset capable of operation on more than one wireless system has means for periodically testing for the availability of at least one system whilst operatively connected to another system, wherein the periodicity of the testing process is made at one rate when a call is in progress and at a second rate when no call is in progress.

According to a second aspect of the inventions, there is provided a method of periodically testing for the availability of at least one wireless system to a mobile handset capable of operation on more than one wireless system whilst the handset is operatively connected to another system, wherein the periodicity of the testing process is made at one rate when the handset is engaged in a call is in progress, and at a second rate when no call is in progress.

By sampling at a second, preferably slower, rate when no call is in progress, power consumption can be reduced, thereby increasing standby time. As the higher rate is used when a call is in progress, the risk of the call being dropped is not increased. A suitable sampling rate when on standby would be 2 seconds, ten times longer than that used when a call is in progress. As the sampling is the principal drain on the battery when on standby, this would result in a tenfold improvement in battery life when on standby.

In one embodiment of the invention, the rate at which the availability of a first system is sampled whilst operatively connected to a second system is different from the rate at which the availability of the second system is sampled whilst operatively connected to the first system. This arrangement can further reduce overall power consumption, and may be of particular use for combinations of systems in which the radio coverage of one system falls off much more rapidly with distance than the coverage of the other system. For example, the coverage afforded by cellular telephone base stations typically covers many hundreds or thousands of metres, and movement over comparable distances is required for signal quality to vary significantly. Conversely, “Bluetooth” systems generally operate over tens of metres. Consequently, when operating on a cellular system, the rate at which a local system is sampled may be reduced, as there is less risk of losing the cellular connection during the sampling interval.

In another embodiment of the invention, sampling for a first system is performed when operatively connected to a second system, but no sampling for the second system is performed when operatively connected to the first system. Such an arrangement may be appropriate if the first system is always to be used when it is available, for example because of price, bandwidth, or other some other characteristic. In such an arrangement, the second system would never be used if the first is available, so sampling for it is unnecessary. Sampling for the second system is also unnecessary if the second system's service provision is substantially ubiquitous.

Various embodiments of the invention will now be described, by way of example, with reference to the accompanying schematic drawings, in which:

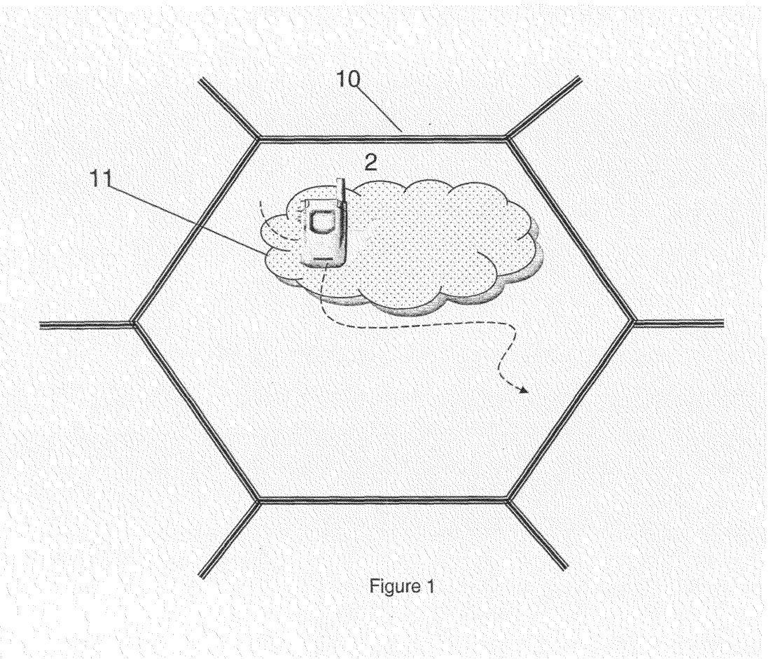

FIG. 1 depicts a mobile handset located in an environment where there are two different types of wireless communication available to it

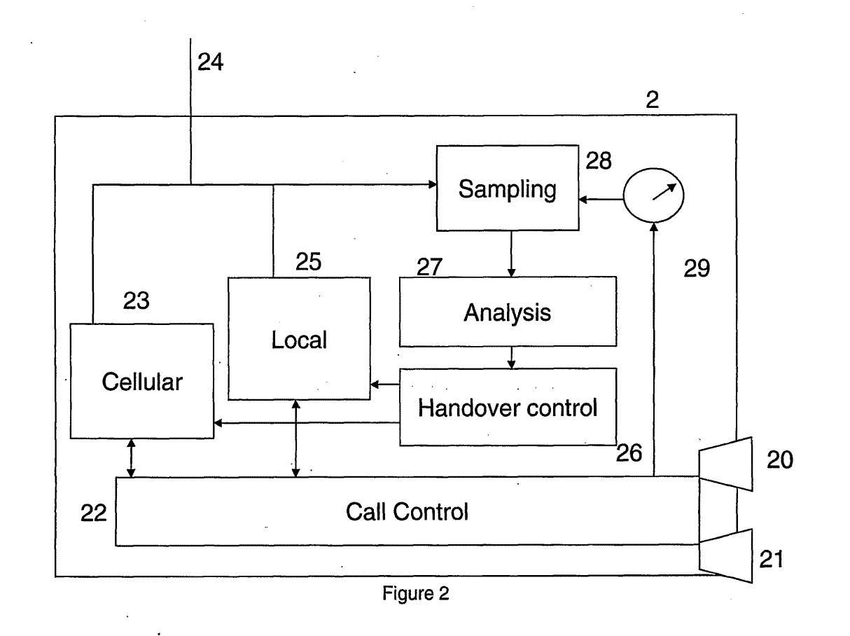

FIG. 2 is a schematic illustration of those components of the mobile handset 2 that are relevant to the present invention.

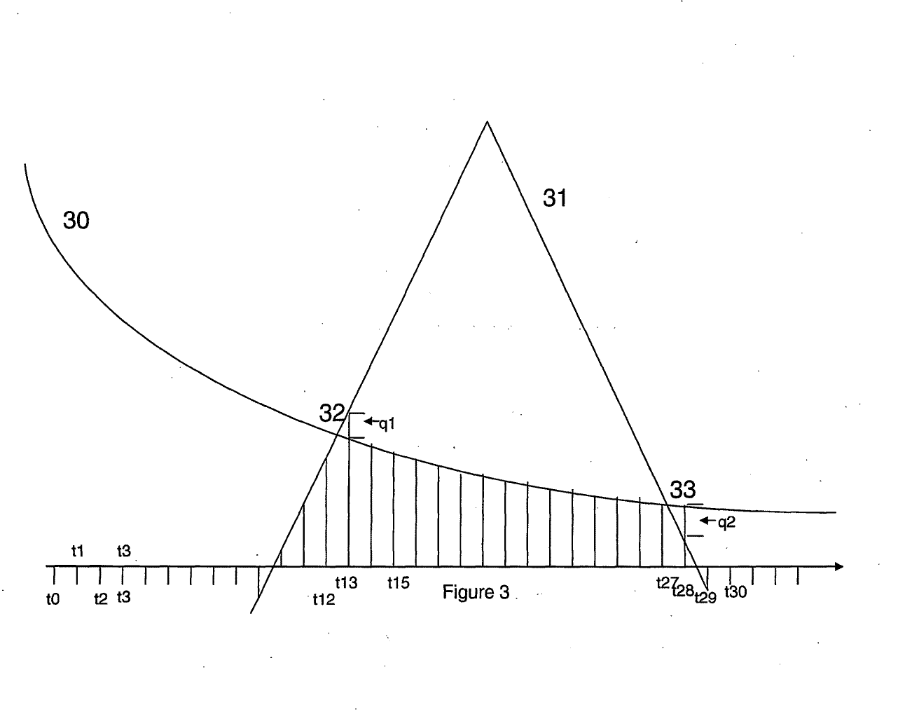

FIG. 3 illustrates the sampling process during the progress of a call;

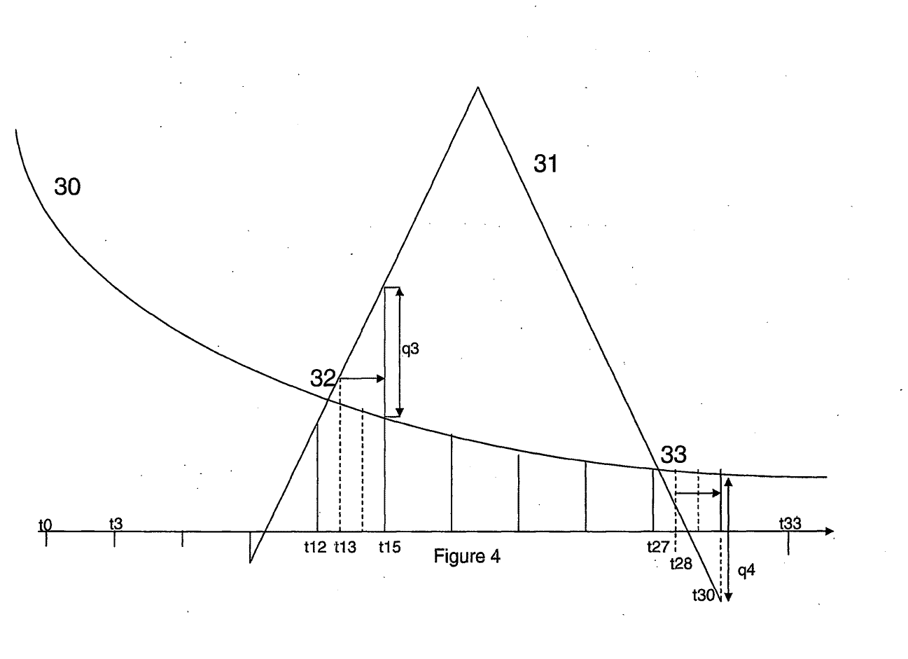

FIG. 4 illustrates the sampling process when the handset is on standby;

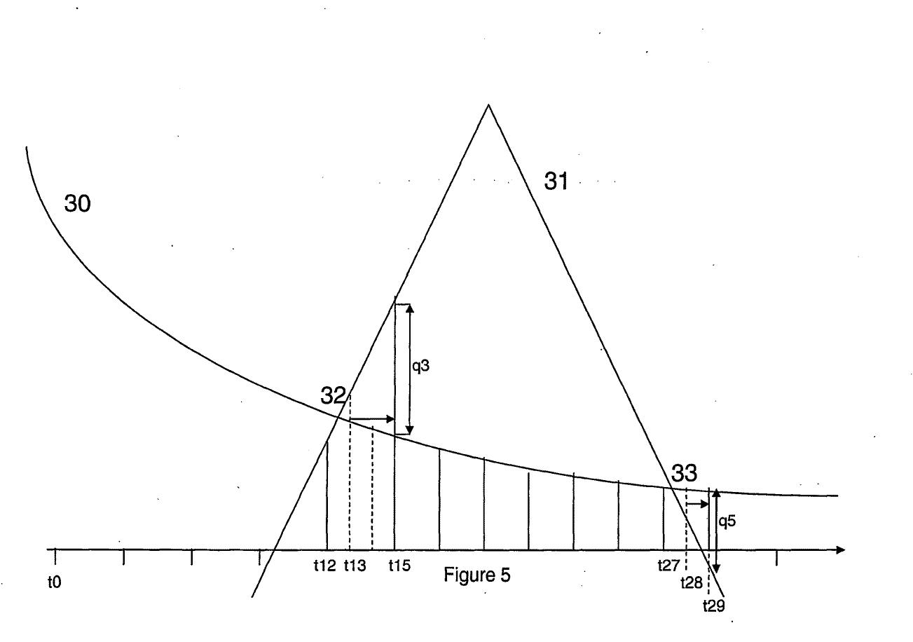

FIG. 5 is a variation on FIG. 4, wherein the standby sampling rate is variable;

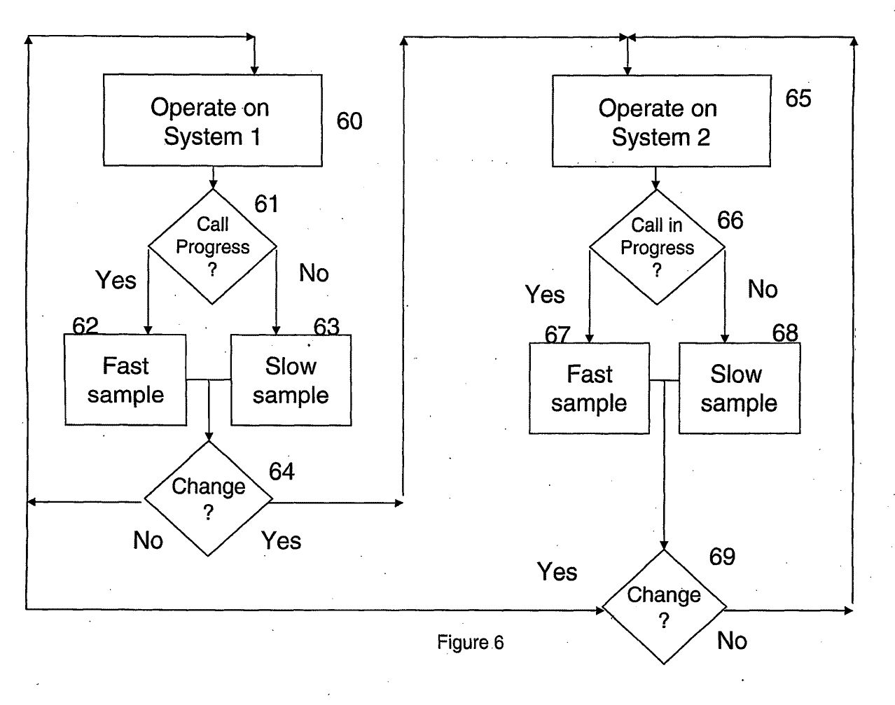

FIG. 6 illustrates as a flow diagram the operation of a handover control system according to the invention.

FIG. 1 depicts a dual-system wireless handset 2 located within a cell 10 of a cellular telephone network, and also located within the coverage area 11 of a short-range wireless system such as “Bluetooth” or “Wi-Fi” (802.11). It will be understood that the coverage areas 10 and 11 do not have clearly defined boundaries, but that their extent depends on factors such as signal quality, both absolute and relative to each other, which vary over distance as shown for example in FIGS. 3 to 5, which are time plots of the signal quality measured by a handset moving across the area depicted in FIG. 1.

As shown in FIG. 2, the mobile handset 2 comprises an earphone 20 and microphone 21, which provide conversion between acoustic and electrical signals. Electrical signals to and from these components are handled by a call control system 22 which performs the analogue/digital conversions and other processes to allow the call to be carried over the telephone system. The call is processed (23) according to the appropriate protocols to allow it to be carried over the cellular telephone network 10 using an antenna 24.

As shown in FIG. 2, the call may be handled by an alternative protocol 25, to allow transmission by a different wireless system 11. For the purposes of illustration, only two different protocols are illustrated, but there may be more. The system which is to be used is selected by a handover control system 26.

The handover control process causes the handset 2 to establish communication with the fixed base station of the network to which it is to be transferred, and to break off communication with the base station with which it was previously co-operating. If a call is currently in progress, this is done in a way that allows continuity of the call. The process may be the same as that used for changing between cells of the cellular system 10. As discussed above, the short-range system 11 may provide an alternative means for connection to the same switching system as the cellular network, but without going through the conventional base stations.

The handover control makes use of analysis 27 of parameters such as signal quality and signal strength on each of the networks 10, 11, based on a periodic sampling 28 of these parameters. The sampling rate is controlled by a clock 29, and is dependant on the current call activity of the handset 2, as communicated to it by the call control system 29.

FIGS. 3, 4, and 5 are time-plots, with time along the horizontal axis, showing the measurements made by a mobile handset of signal quality as it moves steadily across a large scale radio coverage area 10, such as the coverage area 10 of the cellular base station, within which is located the radio coverage area 11 of the small scale station. The respective signal qualities are represented by curves 30, 31. It will be seen that the signal properties 31 associated with the small scale transducer vary much more over a given distance than those of the larger scale cell 30. It will be assumed for this illustration that the system is used that gives the higher signal quality, so the transitions between systems should be at those points labelled 32, 33. However, alternative criteria may be used, for example the small scale system 11 may be used whenever signal quality exceeds a given minimum absolute threshold value, and the cellular system used elsewhere.

The signal quality of the system currently in use is sampled periodically to determine whether handover to another cell of the same system would be appropriate. There are well-established processes to allow handover between two cells of the same system, but handover to another system requires an extra monitoring process, to assess signal quality of that other system. As discussed above, this monitoring consumes additional power. FIG. 3 indicates a sequence of sampling points for the system not currently in use. It will be seen that these sampling points occur at regular intervals t1, t2, t3 etc. At the sampling points up to t12 inclusive, the curve 30 is higher than the curve 31, so the handset operates on the cellular system 10 and it is the local system that is monitored (curve 31). At the first sampling point t13 after the transition point 32, the handset switches to the local system 11 as that now has the better signal quality (the curve 31 is now higher than the curve 30). From the next sampling point t14, it now samples the cellular signal 30, at the same rate as before, until it reaches the sampling point t28, immediately after the second transition point 33, after which it reverts to operating on the cellular system (and sampling the local system) as the quality 31 of the local system 11 has fallen back below that of the cellular system 10.

It will be seen that the signal 30, 31 that is sampled at each sampling point is the one that had the lower value at the previous sampling point. Immediately after a transition point, the handset will identify that it has sampled the better quality signal, and then switches to sampling the other signal.

The sampling interval (the time elapsed between t1, t2, etc) is selected such that the loss of call quality q1, q2 between the actual transition point 32,33 and the next sampling point t13,t28 respectively is acceptable. In practice call quality in small range base stations can fall very abruptly, for example when a user leaves a room, and time must be allowed for a handover to actually take place, so sampling rates of the order of 200 ms are considered appropriate. However, although sampling at such rates requires a power consumption that is low compared with the power consumed during a call, it is high compared with the power consumed on standby, and would significantly reduce standby time.

FIG. 4 illustrates how, according to the invention, the sampling rate may be reduced when the handset is on standby. For clarity of illustration, the sampling rate in this example is only reduced by two-thirds, although in practice reductions of as much as 90% may be possible. It will be seen that the delay between crossing a transition point 32, 33 and the next sample t15, t30 respectively may now be much greater, and the potential loss of call quality q3, q4 consequently also much greater. However, as this slower sampling rate is only used when no call is in progress, no actual impairment is experienced by the user.

It will be seen in FIG. 4 that the potential loss of quality q4 at the second transition point 34 is very deep, because of the steep fall in signal quality with distance of the small scale base station 11. This may make it difficult to re-establish connection to the cellular system 10 should a call be attempted at this time. This is less of a difficulty at the first transition point 32, as the cellular system remains usable, albeit not optimum. To ameliorate this problem, an alternative embodiment varies the standby sampling rate, as shown in FIG. 5, according to the type of system to which the handset is connected. In this example, it remains at one third of the on-call rate when operating on standby to the cellular system, but is reduced by only 50% of the on-call rate when operating on standby to the local base station 11. Consequently, the maximum time that the call quality can be suboptimal is from the transition point 33 to the next sampling point t29, and the maximum quality loss q5 at that transition is reduced.

If the cellular system has ubiquitous cover, so that it can be relied on to be present whenever the preferred but sporadic localised system 11 drops out, sampling need only take place (on call and/or on standby) when the cellular system 10 is in use. Similarly, if the localised system 11 is always preferred over the cellular system 10 provided the localised system is available, no sampling of the cellular system is necessary when the localised system 11 is in use, since a transition to the cellular system would never take place in any situation where both were available.

FIG. 6 illustrates the handover process controlled by this sampling process. The handset is initially operating on one of the two systems 10, 11 (step 60/65). If a call is in progress (decision point 61/66) the sampling rate for the non-operative system is selected to be the fast rate as shown in FIG. 3 (steps 62/67)—otherwise the slower rate shown in FIG. 4 or 5 is used (steps 63/68). If the measurements made on the sample indicate that the handset should switch to the non-operative system (decision point 64/69) then a handover is effected to that-system (65/60 respectively): otherwise the handset continues on the same system as before (60/65)

1. A mobile handset capable of operation on more than one wireless system, having means for periodically testing for the availability of at least one system whilst operatively connected to another system, wherein the periodicity of the testing process is made at one rate when a call is in progress and at a second rate when no call is in progress.

2. A mobile handset according to claim 1, wherein the second rate is slower than the first rate.

3. A mobile handset according to claim 1, wherein the rate at which the availability of a first system is sampled whilst operatively connected to a second system is different from the rate at which the availability of the second system is sampled whilst operatively connected to the first system.

4. A mobile handset according to claim 3, wherein sampling for a first system is performed when operatively connected to a second system, but no sampling for the second system is performed when operatively connected to the first system.

5. A method of periodically testing for the availability of at least one wireless system to a mobile handset capable of operation on more than one wireless system whilst the handset is operatively connected to another system, wherein the periodicity of the testing process is made at one rate when the handset is engaged in a call is in progress, and at a second rate when no call is in progress.

6. A method according to claim 5, wherein the second rate is slower than the first rate.

7. A method according to claim 5, wherein the rate at which the availability of a first system is sampled whilst operatively connected to a second system is different from the rate at which the availability of the second system is sampled whilst operatively connected to the first system.

8. A method according to claim 7, wherein sampling for a first system is performed when operatively connected to a second system, but no sampling for the second system is performed when operatively connected to the first system.
